(19) United States
(12) Patent Application Publication
(10) Pub. No.: US 2026/0205743 A1
(43) Pub. Date: Jul. 16, 2026

(54) hearing aid with a beamformer equivalent with single-channel filtering

(71) Applicant: Oticon A/S, Smørum (DK)

(72) Inventors: Poul HOANG, Smørum (DK); Jan M. DE HAAN, Smørum (DK)

(21) Appl. No.: 19/422,527

(22) Filed: Dec. 17, 2025

(30) Foreign Application Priority Data
Jan. 13, 2025 (EP) 25151488.1

(51) Int. Cl. H04R 25/00; H04R 25/02

(52) U.S. Cl. CPC H04R 25/407; H04R 25/02; H04R 25/505; H04R 25/552; H04R 25/554; H04R 2225/43; H04R 2430/01; H04R 2460/01

(57) ABSTRACT

Disclosed herein are embodiments of a hearing aid where a beamformer equivalent with single-channel filtering is presented. The hearing aid can include a) an input unit providing at a primary electric input signal, b) a frequency band to channel unit providing a first secondary electric signal based on the primary electric input signal, c) a wireless receiver allowing to establish a wireless link with at least another device and receiving at least a second secondary electric signal, d) a first signal provider for providing an output of the first signal provider based on the first secondary electric signal and the second secondary electric signal, e) a second signal provider for providing an output of the second signal provider, f) a distribution unit distributing the input of the distribution unit, g) a processor providing a noise reduced electric signal, and h) an output unit.

### CROSS REFERENCE TO RELATED APPLICATIONS

Any and all applications for which a foreign or domestic priority claim is identified in the Application Data Sheet as filed with the present application are hereby incorporated by reference under 37 CFR 1.57.

### TECHNICAL FIELD

The present application relates to the field of hearing aids.

### BACKGROUND

Hearing aids face challenges in improving speech intelligibility, speech quality of a target speaker, and noise reduction. Beamforming may be considered a technology that combines two or more microphones to change the directionality of a so-called reference microphone. Beamforming may be used to improve the audio quality of a desired sound signal in general. Several beamforming implementations have been provided in the prior art, but single-microphone solutions may not benefit from beamforming. Therefore, single-microphone solutions cannot utilize beamforming, and the noise reduction of single-microphone hearing aids does not perform as well as multi-microphone hearing aids in terms of noise reduction.

### SUMMARY

This disclosure aims to address the above-mentioned challenges that hearing systems comprising at least two single-microphone hearing aids may have by providing a beamformer method with single-channel filtering that may utilize both microphones of said hearing systems without the need to stream the full microphone signals between the hearing aids, which may either not be possible or consume too much power.

In the present disclosure, a hearing aid is provided. In the context of the present disclosure, “user” denotes a person or entity that uses the disclosed hearing aid. The hearing aid comprises an input unit for providing a primary electric signal representing sound in an environment of the user wearing the hearing aid. The primary electric signal may comprise a target signal and a noise signal. The term “environment” refers to the aggregate of surrounding things, conditions, or influences. In the context of the present disclosure, “environment” specifically denotes the acoustic environment. The hearing aid comprises a frequency band to channel unit for providing a first secondary electric signal based on said primary electric signal. The hearing aid comprises a wireless receiver allowing to establish a wireless link and to receive a second secondary electric signal from another device. Said another device may comprise a second hearing aid or an auxiliary device. The auxiliary devices may include at least one of a remote control, a remote microphone, an audio gateway device, an entertainment device, e.g. a music player, a wireless communication device, e.g. a mobile phone (such as a smartphone) or a tablet or any other device, e.g. comprising a graphical interface. The hearing aid comprises a first signal provider for providing an output of the first signal provider based on the first secondary electric signal and the second secondary electric signal received from another device. The hearing aid comprises a second signal provider for receiving a first input of the second signal provider and a second input of the second signal provider and providing an output of the second signal provider in dependence of the first input of the second signal provider and the second input of the second signal provider. The hearing aid comprises a distribution unit for distributing an input of the distribution unit to an output of the distribution unit. The hearing aid comprises a processor for applying the output of the distribution unit or the output of the second signal provider to said primary electric signal and providing a frequency domain noise reduced electric signal. “Applying” may denote multiplying. “Applying” may denote subtracting. The hearing aid comprises an output unit for providing a stimulus perceivable by the user as sound representing a noise reduced electric signal.

In an aspect of the present disclosure, a hearing aid comprising a beamformer with single-channel filtering is provided. The hearing aid may be adapted for being located at or in an ear of a user.

The input unit may be configured to obtain an electric signal representing sound in the environment of the user wearing the hearing aid. The input unit may comprise an input transducer, e.g., a microphone M₁, to transform acoustic energy into a time-domain electric signal. The input unit may comprise an analysis filter bank (FBA) for transforming the time-domain electric signal into said primary electric signal, in the frequency domain. The analysis filter bank may decompose the primary electric signal into a plurality of frequency sub-band signals, where each frequency sub-band signal may be a sinusoidal representation of the primary electric signal. The analysis filter bank may Fourier transform the time-domain electric signal. The primary electric signal may be represented as a frequency sub band representation comprising a number K of frequency bands.

The frequency band to channel unit may comprise a frequency band to channel allocation unit. The frequency band to channel unit may process the primary electric signal for allocating said number K of frequency bands to a number \tilde{K} of frequency channels, where \tilde{K} is smaller than K, providing said first secondary electric signal. For example, one way of implementing said frequency band to channel allocation unit is by determining a K×\tilde{K} real matrix empirically in the laboratory, and then providing the first secondary electric signal as the multiplication of the K-dimensional vector of the primary electric signal times said K×\tilde{K} real matrix. An example of how the frequency band to channel unit may work is described below.

The frequency band to channel allocation unit may comprise a number of band combination units, each configured to provide a—possibly weighted—combination of the contents of two or more of said K frequency bands and to provide a respective one of said \tilde{K} frequency channels. In an embodiment at least one frequency band is not combined with other frequency bands but is provided as one of the frequency channels (i.e. such one of the \tilde{K} frequency channels consist of one of the K frequency bands). One or more of the lowest frequency bands (covering the lowest part of the operating frequency range of the hearing device) is/are provided as corresponding frequency channels (without being combined with other frequency bands). In an embodiment, one or more of the highest frequency bands (covering the highest part of the operating frequency range of the hearing device) is/are not provided as frequency channels (i.e. are not considered) (i.e. are ignored) by the first beamformer. In an embodiment, only frequency bands corresponding to a frequency range (or possibly separate ranges) containing speech components considered to be significant for the user's intelligibility of speech are provided as corresponding frequency channels. In an embodiment, only frequency bands corresponding to a frequency range from 0 to 4 kHz, such as from 0 to 3 kHz, such as from 1 kHz to 3 kHz, are provided as corresponding frequency channels. In some embodiments the first secondary electric signal may comprise corresponding frequency channels.

The number of band combination units comprises a band sum unit configured to provide a—possibly weighted—sum of the contents of two or more of said frequency bands and to provide a respective one of said frequency channels. In an embodiment, the weights are equal to 1, thereby implementing an algebraic sum of frequency bands. In an embodiment, at least two of the weights are different from one. The workings of the band sum unit may be described by said K×\tilde{K} real matrix.

The frequency band to channel allocation unit may comprise a number of down-sampling units, each configured to down-sample a signal of a given one of the \tilde{K} channels with a down-sampling factor and to provide a corresponding down-sampled channel signal. In an embodiment, the down-sampled channel signals are sampled with a frequency smaller than 1 kHz, such as smaller than 600 Hz, e.g. in a range between 100 Hz and 200 Hz. The down-sampled channel signals may, e.g. be used to be exchanged with the other device, i.e. the hearing aid may be configured to transmit the down-sampled channel signal to the other device, and to receive a corresponding down-sampled channel signal from the other device. The down-sampled signal may be used by the first beamformer, instead of the corresponding original (not down-sampled) signal in \tilde{K} frequency bands. Thereby, bandwidth and/or power in a wireless link for exchanging frequency channels (e.g. representing one or more of the electric input signals, and/or combinations thereof, e.g. a resulting beamformed signal), can be decreased (minimized).

The wireless receiver may comprise an antenna and a transceiver circuitry allowing to establish the wireless link and to receive at least the said second secondary electric signal representing sound in the environment of the user wearing the hearing aid from another device.

The hearing aid may comprise a wireless transceiver. The wireless receiver and/or transceiver may e.g. be configured to receive and/or transmit an electromagnetic signal in the radio frequency range (3 kHz to 300 GHz). The wireless receiver and/or transceiver may e.g. be configured to receive and/or transmit an electromagnetic signal in a frequency range of light (e.g. infrared light 300 GHz to 430 THz, or visible light, e.g. 430 THz to 770 THz).

The wireless receiver may comprise an antenna and a transceiver circuitry allowing to establish a wireless link and to receive at least a second secondary electric signal representing sound in the environment of the user wearing the hearing aid from another device. The first beamformer may provide a beamformed signal based on the first secondary electric signal in said number \tilde{K} of frequency channels and said second secondary electric signal received from said another device in said number \tilde{K} of frequency channels.

In an embodiment, the first signal provider is a first beamformer for providing a beamformed electric signal based on the first secondary electric signal and the second secondary electric signal received from another device. In the same embodiment, the second signal provider may be a gain unit for receiving said beamformed electric signal and providing first complex gains in dependence of said beamformed electric signal and at least the first secondary electric signal. In the same embodiment, the hearing aid comprises a distribution unit for distributing said first complex gains to second complex gains. In the same embodiment, the processor may apply said second complex gains to said primary electric signal to provide a noise reduced electric signal.

The first beamformer may comprise a minimum variance distortionless response (MVDR) beamformer. Ideally, the MVDR beamformer keeps the signals from the target direction (also referred to as the look direction) unchanged, while attenuating sound signals from other directions maximally. Many beamformer variants can be found in literature. The linear constraint minimum variance (LCMV) beamformer is widely used in microphone array signal processing. The generalized sidelobe canceller (GSC) structure is an equivalent representation of the MVDR beamformer offering computational and numerical advantages over a direct implementation in its original form.

The gain unit may receive said beamformed signal and provide a first complex gain for each of said number \tilde{K} of frequency channels in dependence of said beamformed signal and the first secondary electric signal.

The distribution unit may distribute the first complex gain for each of said number \tilde{K} of frequency channels to second complex gain for each of said number K of frequency channels. The distribution unit may comprise a linear transformation. The workings of the distribution unit may be described by a matrix, which may be, for example, be the transpose of the K×\tilde{K} real matrix describing the workings of the frequency band to channel unit described above.

The processor may apply a second complex gain for each said number K of frequency channels to said primary electric signal in said number K of frequency channels and provide a noise reduced electric signal in said number K of frequency channels.

In the prior art, beamforming was used to improve speech intelligibility and speech quality of a target speaker. Beamforming may be used to improve audio quality of a desired sound in general, for example music or live entertainment. Beamforming achieves this by changing the directionality of a reference microphone. For example, a beamformer may combine a plurality of omni-directional microphones to create a directional microphone. This can improve speech intelligibility and speech quality of a target speaker, since a directional microphone may be configured to enhance the target speaker by attenuating sounds from other directions than the target speaker. Therefore, the hearing aid provided may improve speech intelligibility. Thereby an improved hearing aid may be provided.

The hearing aid may be adapted to provide a frequency dependent gain and/or a level dependent compression and/or a transposition (with or without frequency compression) of one or more frequency ranges to one or more other frequency ranges, e.g. to compensate for a hearing impairment of a user. The hearing aid may comprise a signal processor for enhancing the input signals and providing a processed output signal.

The gain unit may be understood as a part of the hearing aid's hardware designed for being controlled by the processor for estimating the first complex gains for each said number \tilde{K} of frequency channels by minimizing the mean square error between the beamformed signal and the result of multiplying a post filter gain with one value of an electric signal for each said number \tilde{K} of frequency channels. This estimation may be done, for example, by finding the complex number that minimizes the expected value of the square of the absolute value of the difference between the beamformed signal and the product of such complex number and the first secondary electric signal. The estimation method may be, for example, a Least Mean Square (LMS) method, or a Normalized LMS (NLMS) method.

The frequency band to channel unit may be understood as a part of the hearing aid's hardware designed for being controlled by the processor for comprising a number of band combination units, each configured to provide a combination of the contents of two or more of said number K of frequency bands and to provide a respective one of said number \tilde{K} of frequency channels. The combination of contents of two or more of said number \tilde{K} of frequency bands may be a weighted combination. For example, if K=2\tilde{K}, the combination may be defined as the average between the contents of the k^{th} and the (k+1)^{th} frequency bands, for every k odd number and smaller than K.

The frequency band to channel unit may comprise a number of down-sampling units, each configured to down-sample a signal of a given one of the number \tilde{K} of frequency channels with a down-sampling factor and to provide a corresponding down-sampled channel signal. This may be understood as compressing the primary electric signal into the first secondary electric signal.

The hearing aid may comprise a synthesis filter bank. The synthesis filter bank may be understood as a part of the hearing aid's hardware designed for being controlled by the processor for converting the frequency domain noise reduced electric signal to the time domain.

The hearing aid may comprise an output unit for providing a stimulus perceived by the user as an acoustic signal based on a processed electric signal. The output unit may comprise a receiver (loudspeaker) for providing the stimulus as an acoustic signal to the user (e.g. in an acoustic (air conduction based) hearing aid). The output unit may (additionally or alternatively) comprise a (e.g. wireless) transmitter for transmitting sound picked up-by the hearing aid to another device, e.g. a far-end communication partner (e.g. via a network, e.g. in a telephone mode of operation).

The output unit may be understood as a part of the hearing aid's hardware designed for providing a stimulus perceived by the user as a sound representing the noise reduced electric signal in said number K of frequency bands.

In an embodiment, a first hearing aid may comprise a wireless transceiver. The wireless transceiver may be used to establish a wireless link between a second hearing aid comprising another transceiver. The wireless link may be used to send the first secondary electric signal from the first hearing aid to the second hearing aid. The wireless link may be used to send the second secondary electric signal from the second hearing aid to the first hearing aid. The system comprising the first hearing aid, the second hearing aid, and the wireless link may be understood as a binaural hearing system. The wireless link may be used to send the first secondary electric signal from the first hearing aid to an auxiliary device. The wireless link may be used to send the second secondary electric signal from the auxiliary device to the first hearing aid.

In an embodiment, the first signal provider is a target cancellation unit for reducing the signal produced by a target speaker in the output of the first signal provider. The target cancellation provides a primary target cancelling beamformed electric signal, in said number K of frequency channels, as an output. In the same embodiment, the second signal provider is a noise canceller unit for estimating the noise signal comprised in the first secondary electric signal. The noise canceller unit may take the primary target cancelling beamformed electric signal in said number \tilde{K} of frequency channels, and the first secondary electric signal in said number \tilde{K} of frequency channels as inputs. The noise canceller unit may provide a primary estimated noise signal in said number \tilde{K} of frequency channels. The primary estimated noise signal may be based on the primary target cancelling beamformed electric signal and the first secondary electric signal. In the same embodiment, the distribution unit may take the primary estimated noise signal, in said number \tilde{K} of frequency channels as input and may provide a secondary estimated noise signal in said number K of frequency bands as output. In the same embodiment, the processor subtracts said secondary estimated noise signal in said number K of frequency bands to the primary electric signal in said number K of frequency bands. In the same embodiment, the processor provides a noise reduced electric signal in said number K of frequency bands for being presented as an acoustic signal to the user of the hearing aid. Said noise reduced electric signal may be used by the output unit to provide the user with stimuli perceivable by the user as sound, the stimuli being representative of the noise reduced electric signal. In an embodiment, the estimation methods used by the noise canceller unit comprise a linear minimum mean square error estimator (LMMSEE). This method reduces the expected value of the square of the absolute value of the difference between the first secondary electric signal and the output of the noise canceller unit. In an embodiment, the hearing aid may comprise a voice activity detector for detecting whether or not, or with what probability, the primary electric signal or the first secondary electric signal comprise a signal produced by the voice of a person in an environment of the user of the hearing aid. In an embodiment, the hearing aid may comprise a voice activity detector and the estimation methods used by the noise canceller unit may comprise an LMMSEE, an LMS or any combination thereof. The least mean square method may compute a secondary noise cancelling scalar inductively and based on a previous value of the secondary noise cancelling scalar, a step-size value, an error estimate, and the first secondary electric signal. The least mean square method may compute a primary noise cancelling scalar inductively and based on a previous frame value of the primary noise cancelling scalar, a step-size value, an error estimate, and the primary electric signal. The output of the noise canceller unit may be the product of the conjugate of the primary noise cancelling scalar and the primary target cancelling beamformed electric signal. The output of the noise canceller unit may be the product of the conjugate of the secondary noise cancelling scalar and the secondary target cancelling beamformed electric signal.

In an embodiment, the first signal provider is a target cancellation unit for reducing the signal produced by a target speaker in the output of the first signal provider. The target cancellation provides a primary target cancelling beamformed electric signal, in said number \tilde{K} of frequency channels, as an output. In the same embodiment, the distribution unit may take the primary target cancelling beamformed electric signal, in said number \tilde{K} of frequency channels as input and may provide a secondary target cancelling beamformed electric signal in said number K of frequency bands as output. In the same embodiment, the second signal provider is a noise canceller unit for estimating the noise signal comprised in the first secondary electric signal. The noise canceller unit may take the secondary target cancelling beamformed electric signal in said number K of frequency bands, and the first primary electric signal in said number K of frequency bands as inputs. The noise canceller unit may provide a secondary estimated noise signal in said number K of frequency bands. The secondary estimated noise signal may be based on the secondary target cancelling beamformed electric signal and the first primary electric signal. In the same embodiment, the processor subtracts said secondary estimated noise signal in said number K of frequency bands to the primary electric signal in said number K of frequency bands. In the same embodiment, the processor provides a noise reduced electric signal in said number K of frequency bands for being presented as an acoustic signal to the user of the hearing aid. Said noise reduced electric signal may be used by the output unit to provide the user with stimuli perceivable by the user as sound, the stimuli being representative of the noise reduced electric signal. In an embodiment, the estimation methods used by the noise canceller unit comprise a linear minimum mean square error estimator (LMMSEE). This method reduces the expected value of the square of the absolute value of the difference between the first secondary electric signal and the output of the noise canceller unit. In an embodiment, the hearing aid may comprise a voice activity detector for detecting whether or not, or with what probability, the primary electric signal or the first secondary electric signal comprise a signal produced by the voice of a person in an environment of the user of the hearing aid. In an embodiment, the hearing aid may comprise a voice activity detector and the estimation methods used by the noise canceller unit may comprise an LMMSEE, an LMS, or any combination thereof. The least mean square method may compute a secondary noise cancelling scalar inductively and based on a previous value of the secondary noise cancelling scalar, a step-size value, an error estimate, and the first secondary electric signal. The least mean square method may compute a primary noise cancelling scalar inductively and based on a previous value of the primary noise cancelling scalar, a step-size value, an error estimate, and the primary electric signal. The output of the noise canceller unit may be the product of the conjugate of the primary noise cancelling scalar and the primary target cancelling beamformed electric signal. The output of the noise canceller unit may be the product of the conjugate of the secondary noise cancelling scalar and the secondary target cancelling beamformed electric signal.

In an embodiment, the binaural hearing system comprises a first hearing aid and a second hearing aid configured such that the beamformer weights of the beamformer of the first hearing aid are the same as the beamformer weights of the beamformer of the second hearing aid. In an embodiment, the binaural hearing system comprises a first hearing aid and a second hearing aid configured such that the beamformer weights of the beamformer of the first hearing aid are different from the beamformer weights of the beamformer of the second hearing aid.

In an embodiment, the binaural hearing system comprises at least one hearing aid with at least two input units. The input units of the same hearing aid may comprise an input transducer, e.g. a microphone, to transform acoustic energy into a time-domain electric signal. The input units may comprise a wireless receiver for receiving a wireless signal comprising or representing sound and for providing an electric input signal representing said sound. The input units may comprise an FBA for transforming the time-domain electric signal into a primary electric signal, in the frequency domain, representing sound in the environment of the user wearing the hearing aid. The primary electric signal may be in a frequency sub band representation comprising a number K of frequency bands.

In general, a wireless link established by antenna and transceiver circuitry of the hearing aid can be of any type. The wireless link may be a link based on near-field communication, e.g. an inductive link based on an inductive coupling between antenna coils of transmitter and receiver parts. The wireless link may be based on far-field, electromagnetic radiation. Preferably, frequencies used to establish a communication link between the hearing aid and the other device is below 70 GHz, e.g. located in a range from 50 MHz to 70 GHz, e.g. above 300 MHz, e.g. in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g. defined by the International Telecommunication Union, ITU). The wireless link may be based on a standardized or proprietary technology. The wireless link may be based on Bluetooth technology (e.g. Bluetooth Low-Energy technology, e.g. LE audio), or Ultra WideBand (UWB) technology.

The hearing aid may be constituted by or form part of a portable (i.e. configured to be wearable) device, e.g. a device comprising a local energy source, e.g. a battery, e.g. a rechargeable battery. The hearing aid may e.g. be a low weight, easily wearable, device, e.g. having a total weight less than 100 g, such as less than 20 g, such as less than 5 g.

An analogue electric signal representing an acoustic signal may be converted to a digital audio signal in an analogue-to-digital conversion process, where the analogue signal is sampled with a predefined sampling frequency or rate fₛ, fₛ being e.g. in the range from 8 kHz to 48 kHz (adapted to the particular needs of the application) to provide digital samples xₘ(k,n) (or Xₘ(n)) at discrete points in time tₙ (or n), each audio sample representing the value of the acoustic signal at tₙ by a predefined number N_{b} of bits, N_{b} being e.g. in the range from 1 to 48 bits, e.g. 24 bits. Each audio sample is hence quantized using N_{b} bits (resulting in 2^{N}^{_{b}} different possible values of the audio sample). A digital sample x has a length in time of 1/fₛ, e.g. 50 μs, for fₛ=20 kHz. A number of audio samples may be arranged in a time frame. A time frame may comprise 64 or 128 audio data samples. Other frame lengths may be used depending on the practical application.

The hearing aid may comprise an analogue-to-digital converter to digitize an analogue input (e.g. from an input transducer, such as a microphone) with a predefined sampling rate, e.g. 20 kHz. The hearing aids may comprise a digital-to-analogue converter to convert a digital signal to an analogue output signal, e.g. for being presented to a user via an output transducer.

The hearing aid, e.g. the input unit, and or the antenna and transceiver circuitry may comprise a transform unit for converting a time domain signal to a signal in the transform domain (e.g. frequency domain or Laplace domain, Z transform, wavelet transform, etc.). The transform unit may be constituted by or comprise a time-frequency (TF) conversion unit for providing a time-frequency representation of an input signal. The time-frequency representation may comprise an array or map of corresponding complex or real values of the signal in question in a particular time and frequency range. The TF conversion unit may comprise a filter bank for filtering a (time varying) input signal and providing a number of (time varying) output signals each comprising a distinct frequency range of the input signal. The TF conversion unit may comprise a Fourier transformation unit (e.g. a Discrete Fourier Transform (DFT) algorithm, or a Short Time Fourier Transform (STFT) algorithm, or similar) for converting a time variant input signal to a (time variant) signal in the (time-)frequency domain. The frequency range considered by the hearing aid from a minimum frequency fₘᵢₙ to a maximum frequency fₘₐₓ may comprise a part of the typical human audible frequency range from 20 Hz to 20 kHz, e.g. a part of the range from 20 Hz to 12 kHz. Typically, a sample rate fₛ is larger than or equal to twice the maximum frequency fₘₐₓ, fₛ≥2fₘₐₓ. A signal of the hearing aid may be split into a number NI of frequency bands (e.g. of uniform width), where NI is e.g. larger than 5, such as larger than 10, such as larger than 50, such as larger than 100, such as larger than 500, at least some of which are processed individually. The hearing aid may be adapted to process a signal in a number NP of different frequency channels (NP≤NI). The frequency channels may be uniform or non-uniform in width (e.g. increasing in width with frequency), overlapping or non-overlapping.

In the present context, a hearing aid, e.g. a hearing instrument, refers to a device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. Such audible signals may e.g. be provided in the form of acoustic signals radiated into the user's outer ears and/or acoustic signals transferred as mechanical vibrations to the user's inner ears through the bone structure of the user's head and/or through parts of the middle ear.

The hearing aid may be configured to be worn in any known way, e.g. as a unit arranged behind the ear with a tube leading radiated acoustic signals into the ear canal or with an output transducer, e.g. a loudspeaker, arranged close to or in the ear canal, as a unit entirely or partly arranged in the pinna and/or in the ear canal, as a unit, e.g. a vibrator, attached to a fixture implanted into the skull bone, etc. The hearing aid may comprise a single unit or several units communicating (e.g. acoustically, electrically or optically) with each other. The loudspeaker may be arranged in a housing together with other components of the hearing aid or may be an external unit in itself (possibly in combination with a flexible guiding element, e.g. a dome-like element).

A hearing aid may be adapted to a particular user's needs, e.g. a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user's hearing data, e.g. an audiogram, using a fitting rationale (e.g. adapted to speech). The frequency and level dependent gain may e.g. be embodied in processing parameters, e.g. uploaded to the hearing aid via an interface to a programming device (fitting system), and used by a processing algorithm executed by the configurable signal processing circuit of the hearing aid.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference labels are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 schematically shows a box diagram with the elementary components of the present disclosure,

FIG. 2 schematically shows a first embodiment of a hearing aid according to the present disclosure,

FIG. 3A schematically shows a second embodiment of a hearing aid according to the present disclosure where an LMMSEE method is used,

FIG. 3B schematically shows a second embodiment of the hearing aid according to the present disclosure where an LMS method is used,

FIG. 4A schematically shows a third embodiment of a hearing aid according to the present disclosure where an LMMSEE method is used,

FIG. 4B schematically shows a third embodiment of the hearing aid according to the present disclosure where an LMS method is used,

FIG. 5 schematically shows an embodiment of a binaural hearing system according to the present disclosure, and

FIG. 6 shows an embodiment of a binaural hearing system according to the present disclosure comprising first and second hearing aids in communication with an auxiliary device.

The figures are schematic and simplified for clarity, and they just show details which are essential to the understanding of the disclosure, while other details are left out. Throughout, the same reference signs are used for identical or corresponding parts.

The scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

In order to provide a detailed description of embodiments, some mathematic notations and formulations are required. Therefore, a list of definitions and basic notations is presented below.

Given a natural number r, define [r] as the set {1, 2, . . . , r}. When [⋅] encloses a sequence of elements separated by commas, it denotes a row vector. Let the superscript H denote the Hermitian conjugate, also referred to as Hermitian transpose, of the matrix or vector marked with the superscript H. Let the superscript T denote the transpose of the matrix or vector marked with the superscript T. Let the superscript * denote the complex conjugate of the complex number marked with the superscript *. Let ⋅ denote the multiplication of two elements and x denote a multiplication in the figures when being inside a circle. Let C^{i×j} be the space of i×j matrices with complex coefficients, for any i,j naturals. Here is a list of variables used:
t: a discrete-time index. The symbol t takes values in the natural numbers and it is not bounded. For example, t=0 may refer to time 0 s, t=1 may refer to time 1/20.000 s, t=2 may refer to 2/20.000 s.
k: a frequency bin/band index. The symbol k relates to frequency and takes values in [K].
\tilde{k}: a frequency bin/band index. The symbol \tilde{k} relates to frequency and takes values in [\tilde{K}].
n: a frame index. The symbol n relates to time, takes values in the natural numbers and it is not bounded.
M: a total number of microphones. The value of M is a natural number.
m: a microphone index. The index m takes values in [M]. For a binaural hearing aid with one microphone in each hearing aid, we have m∈{1,2}.
J: a total number of hearing aids used. The value of J is a natural number. For example, in a binaural hearing aid, we have J=2.
j: a hearing aid index. The index j takes values in [J]. For a binaural hearing aid, we have j∈{1,2}.
xₘ(t): a time domain representation of the m^{th} microphone signal. The value of xₘ(t) is a real number for every natural t.
Xₘ(k,n): a primary electric signal. The primary electric signal xₘ(k,n) represents a TF domain representation of xₘ(t). The primary electric signal xₘ(k,n) is obtained from xₘ(t) using the FBA. The value of xₘ(k,n) is a complex number for every k∈[K] and every natural n.
x(k,n): a stacked vector of xₘ(k,n) over the microphone index, such that x(k,n) takes values in [symbol] ^{m×1}. For example, for a binaural hearing system with one microphone in each hearing aid, we have

$$x ( k , n ) = ( \begin{matrix}{x}_{1} ( k , n ) \\ {x}_{2} ( k , n )\end{matrix} ) .$$

s(k,n): a target signal in the TF domain, e.g. a target speaker. For every k∈[K] and every natural n, the value of s(k,n) is a complex number, hidden and desired to extract from x(k,n). In a hearing aid or binaural hearing system with more than one microphone, it is defined as the target signal that the first microphone would receive in the absence of noise.
\tilde{s}(\tilde{k},n): a secondary target signal in the TF domain, e.g. a target speaker. For every \tilde{k}∈[\tilde{K}] and every natural n, the value of \tilde{s}(\tilde{k},n) is a complex number, hidden and desired to extract from \tilde{x}(\tilde{k},n), which is the stacked vector of \tilde{x}ₘ(\tilde{k},n) defined below.
d(k,n): a primary relative transfer function (RTF) vector. Each element of the vector comprises the relative transfer function from a reference microphone to the microphone in question. For example, the second element may be the transfer function from the first microphone to the second microphone. For example, for a binaural hearing aid with one microphone in each hearing aid, it is defined as the vector

$$d ( k , n ) = ( \begin{matrix}1 \\ {d}_{2} ( k , n )\end{matrix} ) ,$$

where d₂(k,n) is a complex value satisfying x(k,n)=s(k,n)·d(k,n) in the absence of noise.
\tilde{d}(\tilde{k},n): a secondary relative transfer function (RTF) vector. For example, for a binaural hearing aid with one microphone in each hearing aid, it is defined as the vector

$$\tilde{d} ( \tilde{k} , n ) = ( \begin{matrix}1 \\ {\tilde{d}}_{2} ( \tilde{k} , n )\end{matrix} ) ,$$

where \tilde{d}₂(\tilde{k},n) is a complex value satisfying \tilde{x}(\tilde{k},n)=\tilde{s}(\tilde{k},n)·\tilde{d}(\tilde{k},n) in the absence of noise and \tilde{x}(\tilde{k},n) is the stacked vector of \tilde{x}ₘ(\tilde{k},n) defined below.
v(k,n): a stacked vector of the noise component, e.g. ambient noise. The vector v(k,n) is hidden and is desired to be attenuated.
w_{MVDR}(k,n): a vector of MVDR beamformer weights at frequency bin k and frame index n. The vector w_{MVDR}(k,n) is also referred to be the MVDR beamformer. The value of y(k,n) is a complex number for every k∈[K] and every natural n.
B_{MTX}: a distribution matrix to transform (or inverse transform) a TF signal, e.g. x₁(k,n), into a signal in the “band-sum” domain, e.g. \tilde{x}₁(k,n). The distribution matrix B_{MTX} is an element of [symbol] ^{K×\tilde{K}}.
Xₘ(n): a second stacked vector of xₘ(k,n) over the frequency bin index. For every natural n, Xₘ(n) takes value [symbol] ^{1×K}. For every natural n, Xₘ(n) is defined by

$${X}_{m} ( n ) := [ {x}_{m} ( 1 , n ) , {x}_{m} ( 2 , n ) , … , {x}_{m} ( K , n ) ] .$$

\tilde{X}ₘ(n): a transformed second stacked vector of xₘ(k,n) over the frequency bin index. For every natural n and every m∈[M], \tilde{X}ₘ(n) takes values in [symbol] ^{1×\tilde{K}}
\tilde{x}ₘ(\tilde{k},n): a secondary electric signal. The secondary electric signal \tilde{x}ₘ(\tilde{k},n) corresponds to \tilde{X}ₘ(n) unstacked and takes values in the complex numbers. For every natural n and every m∈[M], the values of \tilde{x}ₘ(\tilde{k},n), for every \tilde{k}∈[\tilde{K}] are defined by

$${\tilde{X}}_{m} ( n ) \text{=:} [ {\tilde{x}}_{m} ( 1 , n ) , {\tilde{x}}_{m} ( 2 , n ) , … , {\tilde{x}}_{m} ( \tilde{K} , n ) ] .$$

\tilde{x}(\tilde{k},n): a stacked vector of \tilde{x}ₘ(\tilde{k},n) over the microphone index. For every natural n and every m∈[M], \tilde{x}(\tilde{k},n) is an element of [symbol] ^{M×1}.
w_{MVDR}(k,n): a primary vector of MVDR beamformer weights at frequency bin k and frame index n. The primary vector of MVDR w_{MVDR}(k,n) is stacked over the microphone index. For every natural n and every k∈[K], the primary vector of MVDR w_{MVDR}(k,n) is an element off [symbol] ^{M×1}.
\tilde{w}_{MVDR}(\tilde{k},n): a secondary vector of MVDR beamformer weights at frequency bin \tilde{k} and frame index n. The secondary vector of MVDR \tilde{w}_{MVDR}(\tilde{k},n) is stacked over the microphone index. For every natural n and every \tilde{k}∈[\tilde{K}], the secondary vector of MVDR \tilde{w}_{MVDR}(\tilde{k},n) is an element of [symbol] ^{M×1}.
\tilde{y}ⱼ(\tilde{k},n): a beamformed signal. The beamformed signal \tilde{y}ⱼ(\tilde{k},n) is an output of the MVDR beamformer. For every natural n, every j∈[J], and every \tilde{k}∈[\tilde{K}], the beamformed signal \tilde{y}ⱼ(\tilde{k},n) is a complex number.
yⱼ(k,n): a noise reduced electric signal. The noise reduced electric signal yⱼ(k,n) is a complex number for every natural n, every j∈[J], and every k∈[K].
\tilde{g}ⱼ(\tilde{k},n): a primary post filter gain (complex valued) for every hearing aid j, natural n, and frequency bin \tilde{k}.
\tilde{g}ⱼ(n): a stacked primary post filter gain vector. For every hearing aid j, and natural n, the stacked primary post filter gain vector \tilde{g}ⱼ(n) is stacked over the frequency bin index \tilde{k} and is an element of [symbol] ^{1×\tilde{K}}.
gⱼ(k,n): a secondary post filter gain (complex valued) for every hearing aid j, natural n, and frequency bin \tilde{k}.
gⱼ(n): a stacked secondary post filter gain vector. For every hearing aid j, and natural n, the stacked secondary post filter gain vector gⱼ(n) is stacked over the frequency bin index k and is an element of [symbol] ^{1×K}.
\tilde{w}_{tc}(\tilde{k},n): a secondary vector of target cancelling beamformer weights at frequency bin \tilde{k} and frame index n. The secondary vector \tilde{w}_{tc}(\tilde{k},n) is stacked over the hearing aid index. For every natural n and every \tilde{k}∈[\tilde{K}], the secondary vector \tilde{w}_{tc}(\tilde{k},n) is an element of [symbol] ^{J×1}. For example, if J=2, the secondary vector \tilde{w}_{tc}(\tilde{k},n) is defined by

$${\tilde{w}}_{t c} ( \tilde{k} , n ) := [ \begin{matrix}1 \\ 0\end{matrix} ] - \frac{\tilde{d} ( \tilde{k} , n )}{{‖ \tilde{d} ( \tilde{k} , n ) ‖}^{2}} , or {\tilde{w}}_{t c} ( \tilde{k} , n ) := [ \begin{matrix}1 \\ 0\end{matrix} ] - \tilde{d} ( \tilde{k} , n ) .$$

μ: a step-size. The value of μ is a real number. β(k,n): a primary noise cancelling scalar. The purpose of it is to scale and phase shift the initial noise estimate by the target canceller, so that the scaled and phase shifted noise signal match the noise signal present in the corresponding primary electric signal xⱼ(k,n). For every natural n and every k∈[K], the value of the primary noise cancelling scalar β(k,n) is a complex number.
\tilde{β}(\tilde{k},n): a secondary noise cancelling scalar. The purpose of it is to scale and phase shift the initial noise estimate by the target canceller, so that the scaled and phase shifted noise signal match the noise signal present in the corresponding secondary electric signal \tilde{x}ⱼ(\tilde{k},n). For every natural n and every \tilde{k}∈[\tilde{K}], the value of the secondary noise cancelling scalar \tilde{β}(\tilde{k},n) is a complex number.
e(k,n): a primary error estimate. For every natural n and every k∈[K], the value of the primary error estimate e(k,n) is a complex number.
\tilde{e}(\tilde{k},n): a secondary error estimate. For every natural n and every \tilde{k}∈[\tilde{K}], the value of the secondary error estimate \tilde{e}(\tilde{k},n) is a complex number.
\tilde{v}ₑ(\tilde{k},n): a primary estimated noise signal. For every natural n and every \tilde{k}∈[\tilde{K}], the value of the primary estimated noise signal \tilde{v}ₑ(\tilde{k},n) is a complex number.
\tilde{v}ₑ(n): a stacked primary estimated noise signal vector. For every natural n, the stacked primary estimated noise signal vector \tilde{v}ₑ(n) is stacked over the frequency bin index \tilde{k} and is an element of [symbol] ^{1×\tilde{K}}.
vₑ(k,n): a secondary estimated noise signal. For every natural n and every k∈[K], the value of the secondary estimated noise signal vₑ(k,n) is a complex number.
vₑ(n): a stacked secondary estimated noise signal vector. For every natural n, the stacked secondary estimated noise signal vector vₑ(n) is stacked over the frequency bin index k and is an element of [symbol] ^{1×K}.
VAD(κ,n): an output of the voice activity detector. For every κ∈[K](or κ∈[\tilde{K}]) and every natural n, the output of the voice activity detector takes values between 0 and 1. VAD(κ,n)=1 may mean that at the frequency bin κ and frame index n of the input of the voice activity detector, there is a speech detected. VAD(κ,n)=0 may mean that at the frequency bin κ and frame index n of the input of the voice activity detector, there is no speech detected.

Having defined above the mathematical objects necessary to explain the workings of the present disclosure, an aspect of the present disclosure may be described below.

Let us now describe the general problem and a solution described by the present disclosure with an embodiment where a hearing aid comprises M input transducers, e.g. microphones. Assume that the hearing aid is located in a room where there is a speaker producing a target signal that the hearing aid user is interested in listening to. Assume also that in the room where there is the speaker and the hearing aid user, there is noise the hearing aid user is not interested in listening to. Let xₘ(t) be the time-domain signal captured by the m^{th} microphone of the (monaural) hearing aid, for every m in [M], where t is the discrete time index. Then, each time-domain signal xₘ(t) is transformed into the time-frequency domain at the analysis filter bank FBA, resulting in a primary electric signal xₘ(k,n), where k is the frequency bin index and n is the frame index. The vector representation of all microphone inputs in the time-frequency domain is denoted by the stacked vector x(k,n):=[x₁(k,n), x₂(k,n), . . . , x(k,n)]^{T}. The unprocessed microphone signal, which may be referred to as a noisy signal, can be modelled as a sum with two addends, one corresponding to the target signal and the other one corresponding to the noise signal in the time-frequency domain, i.e.

$$x ( k , n ) = s ( k , n ) \cdot d ( k , n ) + v ( k , n ) ,$$

where s(k,n) is the desired signal at the reference input transducer (in this case, microphone 1), e.g. the front microphone on a hearing aid, d(k,n) is the RTF vector (encoding the relative acoustics between the input transducers to the reference input transducers), and v(k,n) is the stacked vector of the noise component of x(k,n). Typically, the MVDR beamformer is used to suppress v(k,n). The MVDR beamformer is a linear combination of the elements of x(k,n) which minimizes the noise power at the output of the beamformer constrained to have a distortionless respond on the desired signal RTF vector. In the prior art, the output of the MVDR beamformer is defined by

$$y ( k , n ) := {w}_{M V D R}^{H} ( k , n ) \cdot x ( k , n ) ,$$

where w_{MVDR}(k,n) is the primary vector of MVDR beamformer weights. The MVDR beamformer weights are computed or estimated. Note that x(k,n) is involved in the computation of the output of the beamformer. This may be a problem if the data bandwidth is limited and only a wireless link is available between the input transducers.

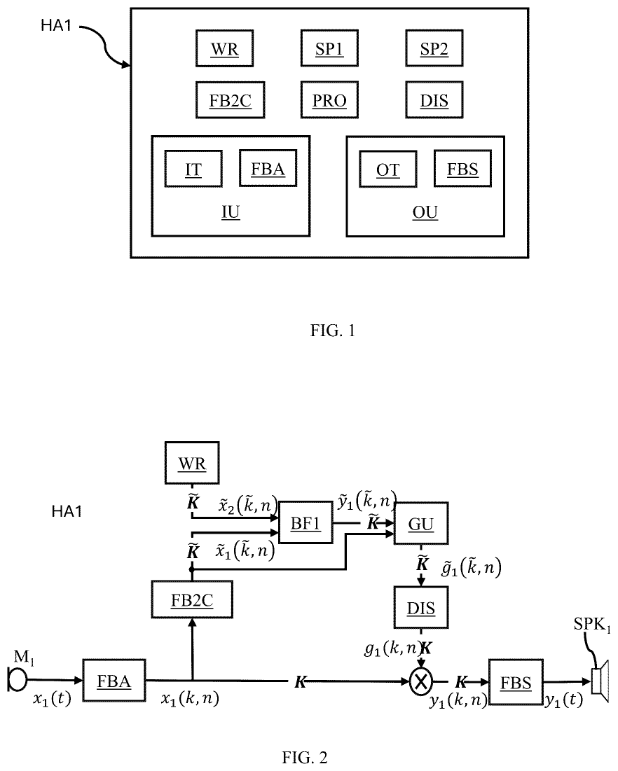

FIG. 1 schematically show a box diagram with the elementary components of the hearing aid HA1 disclosed. The hearing aid HA1 comprises an input unit IU comprising an input transducer IT, e.g. a microphone M₁, to transform acoustic energy into a time-domain electric signal x₁(t). The input unit IU comprises an analysis filter bank FBA for transforming the time-domain electric signal x₁(t) into a primary electric signal x₁(k,n), in the frequency domain. The analysis filter bank may decompose the primary electric signal into a plurality of frequency sub-band signals, where each frequency sub-band signal may be a sinusoidal representation of the primary electric signal. The analysis filter bank may Fourier transform the time-domain electric signal. The primary electric signal x₁(k,n) may be represented as a frequency sub band representation comprising a number K of frequency bands.

In the embodiment of FIG. 1, the hearing aid HA1 comprises a frequency band to channel unit FB2C comprising a number of band combination units, each configured to provide a combination of the content of two or more of said number K of frequency bands of said primary electric signal x₁(k,n) and to provide a respective one of a number \tilde{K} of frequency channels, for providing a first secondary electric signal \tilde{x}₁(\tilde{k},n) in said number \tilde{K} of frequency channels based on said primary electric signal x₁(k,n) in said number K of frequency bands. The combination of contents of two or more of said number \tilde{K} of frequency bands may be a weighted combination. For example, if K=2\tilde{K}, the combination may be defined as the average between the contents of the k^{th} and the (k+1)^{th} frequency bands, for every k odd number and smaller than K. For example, if K=3\tilde{K}, the combination may be defined as the average between the contents of the (k−2)^{th}, the (k−1)^{th} and the k^{th} frequency bands, for every k multiple of 3, greater than 0, and smaller or equal than K. The frequency band to channel unit FB2C of the hearing aid HA1 may receive the primary electric signal x₁(k,n), where k∈[K], which may be expressed in the form of the second stacked vector X₁(n), which is stacked over the frequency bin index k, and outputs the first secondary electric signal \tilde{x}₁(k,n), where \tilde{k}∈[\tilde{K}], defined by the transformed second stacked vector \tilde{X}₁(n), which may be computed for every natural n using the distribution matrix B_{MTX} and the expression \tilde{X}₁(n):=X₁(n)·B_{MTX}. Note that if we had an m^{th} second stacked vector Xₘ(n), for m greater than 1, defined from an m^{th} primary electric signal xₘ(k,n), the transformed m^{th} second stacked vector \tilde{X}ₘ(n), may be analogously computed by \tilde{X}ₘ(n):=Xₘ(n)·B_{MTX}. The real-valued distribution matrix B_{MTX} may be estimated as explained previously in the present disclosure. The first secondary electric signal \tilde{x}₁(\tilde{k},n) may be understood as a compressed signal and applying the distribution matrix B_{MTX} may be understood as a compression method.

In the embodiment of FIG. 1, the hearing aid HA1 comprises a wireless receiver WR comprising a wireless receiver WR allowing to establish a wireless link and to receive a second secondary electric signal \tilde{x}₂(\tilde{k},n). The wireless receiver may comprise an antenna and a transceiver circuitry allowing to establish a wireless link and to receive at least a second secondary electric signal \tilde{x}₂(\tilde{k},n) representing sound in the environment of the user wearing the hearing aid from another device. Said another device may be a second hearing aid HA2 or an auxiliary device AD. The auxiliar device may comprise a tablet, a smartphone, any other device, e.g. comprising a graphical device, or any combination thereof.

In the embodiment of FIG. 1, the hearing aid HA1 comprises a first signal provider SP1 for providing an output of the first signal provider in said number \tilde{K} of frequency channels based on at least said first secondary electric signal \tilde{x}₁(\tilde{k},n) in said number \tilde{K} of frequency channels and the second secondary electric signal \tilde{x}₂(\tilde{k},n) in said number \tilde{K} of frequency channels received from said another device.

In the embodiment of FIG. 1, the hearing aid HA1 comprises a second signal provider SP2 for receiving a first input of the second signal provider and a second input of the second signal provider and providing an output of the second signal provider in dependence of the first input of the second signal provider and the second input of the second signal provider.

In the embodiment of FIG. 1, the hearing aid HA1 comprises a processor PRO for controlling the other elementary components of the hearing aid HA1 and processing the corresponding electric signal.

In the embodiment of FIG. 1, the hearing aid HA1 comprises a distribution unit DIS for distributing an input of the distribution unit in said number \tilde{K} of frequency channels to an output of the distribution unit in said number K of frequency bands. The input of the distribution unit DIS may be the output of the first signal provider SP1. The input of the distribution unit DIS may be the output of the second signal provider SP2. The processor PRO may apply the output of the distribution unit in said number K of frequency bands or the output of the second signal provider in said number K of frequency bands and providing a frequency domain noise reduced electric signal y₁(k,n) in said number K of frequency bands for being presented as an acoustic signal to the user of the hearing aid HA1.

In the embodiment of FIG. 1, the hearing aid HA1 comprises an output unit OU comprising a synthesis filter bank FBS for transforming the frequency domain noise reduced electric signal y₁(k,n) in said number K of frequency bands into a time domain noise reduced electric signal y₁(t). The output unit OU comprises an output transducer OT, e.g. a loudspeaker SPK₁, for providing a stimulus perceived by the user as sound.

The elementary components in FIG. 1 are present in all the embodiments of the present disclosure.

FIG. 2 shows a schematic block diagram description of a first embodiment of a hearing aid HA1 according to the present disclosure.

The hearing aid HA1 comprises a microphone M₁ configured to transform acoustic energy into a time-domain electric signal x₁(t). The time-domain electric signal x₁(t) is provided to an analysis filter bank FBA for transforming the time-domain electric signal x₁(t) into a primary electric signal x₁(k,n), in the frequency domain. The analysis filter bank may Fourier transform the time-domain electric signal. The primary electric signal x₁(k,n) may be represented as a frequency sub band representation comprising a number K of frequency bands.

The primary electric signal x₁(k,n) is then provided to a frequency band to channel unit FB2C comprising a number of band combination units, each configured to provide a combination of the content of two or more of said number K of frequency bands of said primary electric signal x₁(k,n) and to provide a first secondary electric signal \tilde{x}₁(\tilde{k},n) comprising number \tilde{K} of frequency channels based on said primary electric signal x₁(k,n) in said number K of frequency bands. The combination of contents of two or more of said number \tilde{K} of frequency bands may be a weighted combination. For example, if K=2\tilde{K}, the combination may be defined as the average between the contents of the k^{th} and the (k+1)^{th} frequency bands, for every k odd number and smaller than K. For example, if K=3\tilde{K}, the combination may be defined as the average between the contents of the (k−2)^{th}, the (k−1)^{th}, and the k^{th} frequency bands, for every k multiple of 3, greater than 0, and smaller or equal than K. The frequency band to channel unit FB2C of the hearing aid HA1 may receive the primary electric signal x₁(k,n), where k∈[K], which may be expressed in the form of the second stacked vector X₁(n), which is stacked over the frequency bin index k, and outputs the first secondary electric signal \tilde{x}₁(\tilde{k},n), where \tilde{k}∈[\tilde{K}], defined by the transformed second stacked vector \tilde{X}₁(n), which may be computed for every natural n using the distribution matrix B_{MTX} and the expression \tilde{X}₁(n):=X₁(n)·B_{MTX}. Note that if we had an m^{th} second stacked vector Xₘ(n), for m greater than 1, defined from an m^{th} primary electric signal xₘ(k,n), the transformed m^{th} second stacked vector \tilde{X}ₘ(n), may be analogously computed by \tilde{X}ₘ(n) Xₘ(n)·B_{MTX}. The real-valued distribution matrix B_{MTX} may be estimated as explained previously in the present disclosure. The first secondary electric signal \tilde{x}₁(\tilde{k},n) may be understood as a compressed signal and applying the distribution matrix B_{MTX} may be understood as a compression method.

FIG. 2 shows a hearing aid HA1 where the first signal provider SP1 is a first beamformer BF1 for providing a beamformed signal \tilde{y}₁(\tilde{k},n) based on the first secondary electric signal \tilde{x}₁(\tilde{k},n) and at least the second secondary electric signal \tilde{x}₂(\tilde{k},n) received from said other device. FIG. 2 shows a hearing aid HA1 where the second signal provider SP2 is a gain unit GU for receiving the beamformed signal \tilde{y}₁(\tilde{k},n) and at least the first secondary electric signal \tilde{x}₁(\tilde{k},n) and providing first complex gains \tilde{g}₁(\tilde{k},n) in dependence of the beamformed signal \tilde{y}₁(\tilde{k},n) and at least the first secondary electric signal \tilde{x}₁(\tilde{k},n). FIG. 2 shows a hearing aid HA1 comprising a distribution unit DIS for distributing the first complex gains \tilde{g}₁(\tilde{k},n) to provide second complex gains gₗ(k,n). FIG. 2 shows a hearing aid HA1 comprising a processor for applying the second complex gains g₁(k,n) to the primary electric signal x₁(k,n) and providing a noise reduced electric signal y₁(k,n) for being presented as an acoustic signal to the user of a hearing aid. The input unit of the hearing aid HA1 in FIG. 2 comprises a transducer, e.g. a microphone M₁, and an analysis filter bank FBA. The processor of the hearing aid HA1 in FIG. 2 provides a processed output that is fed to a synthesis filter bank (FBS) for conversion from the TF representation (frequency domain) to the time domain. Time domain output signal y₁(t) is fed to an output unit, e.g. a speaker SPK₁, for conversion to stimuli perceivable by the user as sound, e.g. acoustic vibrations (e.g. in air).

In the embodiment depicted in FIG. 2, the beamformer BF1 receives 1) the first secondary electric signal \tilde{x}₁(\tilde{k},n) from the frequency band to channel unit FB2C and 2) the second secondary electric signal \tilde{x}₂(\tilde{k},n) received from said another device through the wireless receiver WR, and provides the beamformed signal \tilde{y}₁(k,n), which is the output of the MVDR beamformer, where the beamformed signal \tilde{y}₁(\tilde{k},n) is defined by

$${\tilde{y}}_{1} ( \tilde{k} , n ) := {\tilde{w}}_{M V D R}^{H} ( \tilde{k} , n ) \cdot x ( k , n ) ,$$

where \tilde{w}_{MVDR}(\tilde{k},n) is the secondary vector of MVDR beamformer weights at frequency bin \tilde{k} and frame index n and x(k,n) is the stacked vector of \tilde{x}ₘ(\tilde{k},n) over the index m∈{1,2}. The complex-valued secondary vector of MVDR beamformer weights \tilde{w}_{MVDR}(\tilde{k},n) may be estimated in any way known from the prior art or any combination of the ways known in the prior art.

In the embodiment depicted in FIG. 2, the gain unit GU receives the beamformed signal \tilde{y}₁(\tilde{k},n) and the first secondary electric signal \tilde{x}₁(\tilde{k},n) and returns the complex-valued primary filter gain \tilde{g}₁(\tilde{k},n) for every natural n and every \tilde{k}∈[\tilde{K}], defined by an optimization equation

$${\tilde{g}}_{1} ( \tilde{k} , n ) := arg {min}_{h ∈ ℂ} 𝔼 [ {\vert {\tilde{y}}_{1} ( \tilde{k} , n ) - {h}^{*} \cdot {\tilde{x}}_{1} ( \tilde{k} , n ) \vert}^{2} ] ,$$

where [symbol] [⋅] is the expectation operator. The goal is to find a complex-valued first gain \tilde{g}₁(k,n) that minimizes the squared error between the beamformed signal \tilde{y}₁(k,n) and the electric signal \tilde{x}₁(\tilde{k},n), which may be noisy. In other words, we seek to find an adaptive filter for the electric signal \tilde{x}₁(k,n) that approximates the output of the beamformer. The solution to the optimization problem is given as

$${\tilde{g}}_{1} ( \tilde{k} , n ) := \frac{𝔼 {\tilde{y}}_{1} ( \tilde{k} , n ) \cdot {\tilde{x}}_{1} ( \tilde{k} , n ) ]}{𝔼 [ {\vert {\tilde{x}}_{1} ( \tilde{k} , n ) \vert}^{2} ]} ,$$

which, in practice, may be approximated with a first order recursive smoothing, resulting in

$${\tilde{g}}_{1} ( k , n ) \approx \frac{〈 {\tilde{y}}_{1}^{*} ( \tilde{k} , n ) \cdot {\tilde{x}}_{1} ( \tilde{k} , n ) 〉}{〈 {\vert {\tilde{x}}_{1} ( \tilde{k} , n ) \vert}^{2} 〉} ,$$

Where, [symbol] denotes a first order smoothing. In some embodiments, the optimization equation defined above may be solved using any iterative solver based on gradient descent, e.g., LMS or NLMS.

The general idea described above, representing the workings of the gain unit depicted in FIG. 1, is to approximate the output of a beamformer with a single-channel filter BF1. A single-channel filter BF1 may be understood as a gain value which is allowed to be complex-valued in contrast to a conventional single-channel filter which is often a real-valued gain. Specifically, the embodiment of FIG. 2. comprises a single-channel beamformer BF1 that approximates the output of a two-channel beamformer.

In the embodiment of FIG. 2, the distribution unit DIS receives the stacked filter gain vector \tilde{g}₁(n) and applies the Hermitian of the distribution matrix B_{MTX} to produce the stacked secondary filter gain vector g₁(n) according to

$${g}_{1} ( n ) := {\tilde{g}}_{1} ( n ) \cdot {B}_{MTX}^{H} .$$

For every natural n and every microphone m∈{1,2}, the secondary filter gain gₘ(k,n) for every k∈[K] may be obtained from the stacked secondary filter gain vector gₘ(n).

In the embodiment of FIG. 2, the processor receives the secondary filter gain g₁(k,n) for every k∈[K] and the electric signal \tilde{x}₁(\tilde{k},n) to produce the noise reduced electric signal y₁(k,n). The noise reduced electric signal y₁(k,n) may be produced according to y₁(k,n):=g₁*(k,n)·x₁(k,n). The noise reduced electric signal y₁(k,n) may be received by the synthesis filter bank FBS, which may transform the noise reduced electric signal y₁(k,n) into the time domain y₁(t), to be sent to the output unit, e.g. the speaker SPK₁, for being presented as sound to the user of the hearing aid HD1.

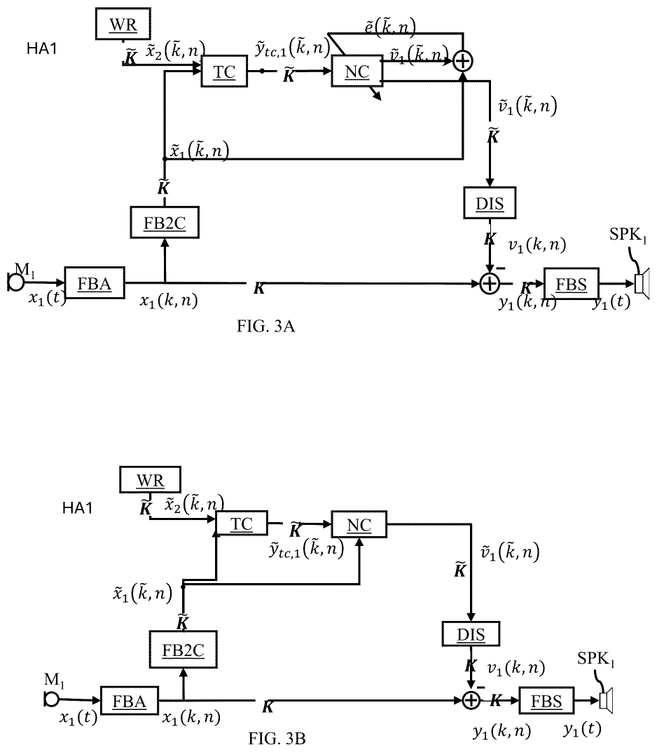

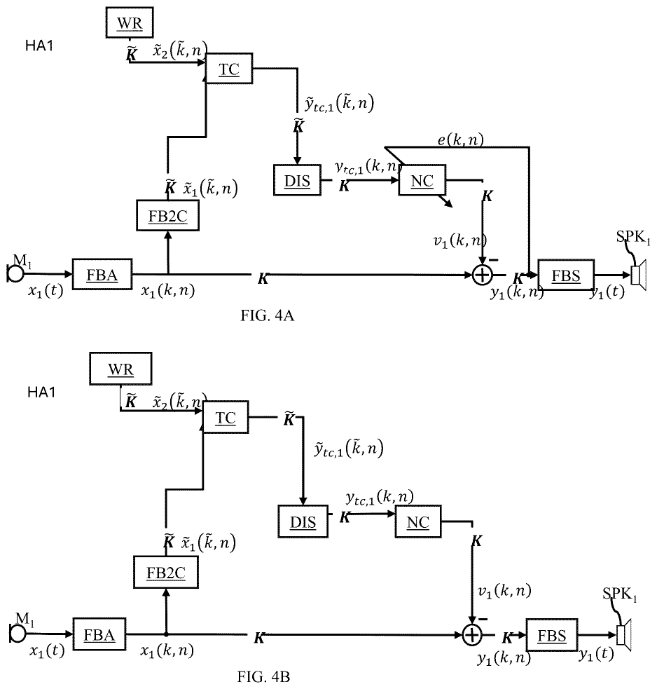

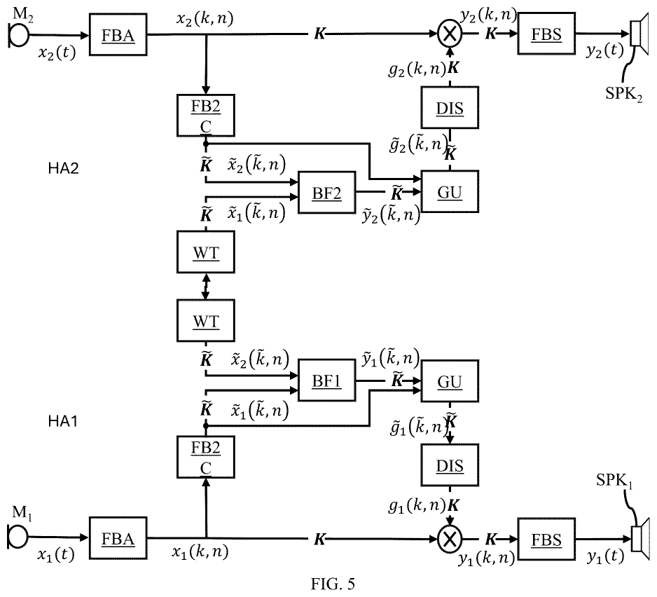

In the embodiments of FIGS. 3A-3B and 4A-4B, the first signal provider SP1 is a target cancellation unit (TC) for reducing the signal produced by a target speaker in the ouput of the first signal provider. In the embodiments of FIGS. 3A-3B and 4A-4B, the output of the first signal provider is a primary target cancelling beamformed electric signal \tilde{y}_{tc,1}(\tilde{k},n) in said number \tilde{K} of frequency channels computed according to

$${\tilde{y}}_{t c , 1} ( \tilde{k} , n ) := {\tilde{w}}_{t c}^{H} ( \tilde{k} , n ) \cdot \tilde{x} ( \tilde{k} , n ) ,$$

for every natural n and every \tilde{k}∈[\tilde{K}], and where

$${\tilde{w}}_{t c}^{H} ( \tilde{k} , n )$$

is the secondary vector of target cancelling beamformer weights at frequency bin \tilde{k} and frame index n. In the embodiments of FIGS. 3A-3B and 4A-4B, the second signal provider SP2 is a noise canceller unit NC for estimating the noise signal comprised in the first secondary electric signal \tilde{x}₁(\tilde{k},n). In the embodiments of FIGS. 3A-3B and 4A-4B, the processor is configured to subtract the secondary estimated noise signal vₑ(k,n), defined from the stacked secondary estimated noise signal vector vₑ(n), to the primary electric signal x₁(k,n) and to provide the noise reduced electric signal y₁(k,n), for every natural n and every k∈[K].

In the embodiments of FIGS. 3A-3B, the first input of the noise canceller unit is the primary target cancelling beamformed electric signal \tilde{y}_{tc,1} (\tilde{k},n) in said number \tilde{K} of frequency channels. In the embodiments of FIGS. 3A-3B, the second input of the noise canceller unit is the first secondary electric signal \tilde{x}₁(\tilde{k},n) in said number \tilde{K} of frequency channels. In the embodiments of FIGS. 3A-3B, the output of the noise canceller unit is a primary estimated noise signal \tilde{v}ₑ(\tilde{k},n) in said number \tilde{K} of frequency channels. In the embodiments of FIGS. 3A-3B, the input of the distribution unit is the primary estimated noise signal \tilde{v}ₑ(\tilde{k},n) in said number \tilde{K} of frequency channels. In the embodiments of FIGS. 3A-3B, the output of the distribution unit is a secondary estimated noise signal vₑ(k,n) in said number K of frequency bands and it may be calculated according to

$${v}_{e} ( n ) := {\tilde{v}}_{e} ( n ) \cdot {B}_{M T X}^{H} ,$$

where vₑ(n) is the stacked secondary estimated noise signal vector, stacked over the frequency bin index k, and \tilde{v}ₑ(n) is the stacked primary estimated noise signal vector, stacked over the frequency bin index \tilde{k}.

In the embodiment of FIG. 3A, the estimation methods in the noise canceller unit NC comprise a LMS method. In the embodiment of FIG. 3A, the hearing aid HA1 comprises a voice activity detector for detecting whether or not, or with what probability, the first secondary electric signal \tilde{x}₁(\tilde{k},n) comprises a signal produced by the voice of a person in an environment of the user of the hearing aid HA1. In the embodiment of FIG. 3A, the primary estimated noise signal \tilde{v}ₑ(\tilde{k},n) may be computed for every natural n and every \tilde{k}∈[\tilde{K}] according to

$${\tilde{v}}_{e} ( \tilde{k} , n ) := \tilde{β} ( \tilde{k} , n ) \cdot {\tilde{y}}_{t c , 1} ( \tilde{k} , n ) ,$$

where the secondary noise cancelling scalar \tilde{β}(\tilde{k},n) is defined, for every natural n greater than 1 and every \tilde{k}∈[\tilde{K}], by

$$\tilde{β} ( \tilde{k} , n ) := \tilde{β} ( \tilde{k} , n - 1 ) + μ \cdot \tilde{e} ( \tilde{k} , n ) \cdot {\tilde{x}}_{1} ( \tilde{k} , n ) \cdot ( 1 - V A D ( \tilde{k} , n ) ) ,$$

where μ is the step-size, \tilde{e}(\tilde{k},n) is the secondary error estimate defined for every natural n and every \tilde{k}∈[\tilde{K}] by

$$\tilde{e} ( \tilde{k} , n ) := {\tilde{x}}_{1} ( \tilde{k} , n ) - {\tilde{β}}^{*} ( \tilde{k} , n - 1 ) \cdot {\tilde{y}}_{t c , 1} ( \tilde{k} , n ) ,$$

and VAD(\tilde{k},n) is the output of the voice activity detector. For n=1, the secondary noise cancelling scalar \tilde{β}(\tilde{k},1) may be defined to be 0, for every \tilde{k}∈[\tilde{K}].

In the embodiment of FIG. 3B, the estimation methods in the noise canceller unit NC comprise a LMMSEE method. In the embodiment of FIG. 3B, the primary estimated noise signal \tilde{v}ₑ(\tilde{k},n) may be computed for every natural n and every \tilde{k}∈[\tilde{K}] according to

$${\tilde{v}}_{e} ( \tilde{k} , n ) := \tilde{β} ( \tilde{k} , n ) \cdot {\tilde{y}}_{t c , 1} ( \tilde{k} , n ) ,$$

where the secondary noise cancelling scalar \tilde{β}(\tilde{k},n) is defined, for every natural n and every \tilde{k}∈[\tilde{K}], by

$$\tilde{β} ( \tilde{k} , n ) := arg {min}_{h ∈ ℂ} 𝔼 [ {\vert {\tilde{x}}_{1} ( \tilde{k} , n ) - {h}^{*} \cdot {\tilde{x}}_{1} ( \tilde{k} , n ) \vert}^{2} ] ,$$

where [symbol] [⋅] is the expectation operator.

In the embodiments of FIGS. 4A-4B, the input of the distribution unit is the primary target cancelling beamformed electric signal \tilde{y}_{tc,1}(\tilde{k},n) in said number \tilde{K} of frequency channels. In the embodiments of FIGS. 4A-4B, the output of the distribution unit is a secondary target cancelling beamformed signal y_{tc,1}(k,n) in said number K of frequency bands. In the embodiments of FIGS. 4A-4B, the first input of the noise canceller unit is the secondary target cancelling beamformed electric signal y_{tc,1}(k,n) in said number K of frequency bands. In the embodiments of FIGS. 4A-4B, the second input of the noise canceller unit is the primary electric signal x₁(k,n) in said number K of frequency bands.

In the embodiment of FIG. 4A, the estimation methods in the noise canceller unit NC comprise a LMS method. In the embodiment of FIG. 4A, the hearing aid HA1 comprises a voice activity detector for detecting whether or not, or with what probability, the first secondary electric signal \tilde{x}₁(\tilde{k},n) comprises a signal produced by the voice of a person in an environment of the user of the hearing aid HA1. In the embodiment of FIG. 4A, the secondary estimated noise signal vₑ(k,n) may be computed for every natural n and every k∈[K] according to

$${v}_{e} ( k , n ) := β ( k , n ) \cdot {y}_{t c , 1} ( k , n ) ,$$

where the primary noise cancelling scalar β(k,n) is defined, for every natural n greater than 1 and every k∈[K], by

$$β ( k , n ) := β ( k , n - 1 ) + μ \cdot e ( k , n ) \cdot {x}_{1} ( k , n ) \cdot ( 1 - V A D ( k , n ) ) ,$$

where μ is the step-size, e(k,n) is the primary error estimate defined for every natural n and every k∈[K] by

$$e ( k , n ) := {x}_{1} ( k , n ) - β * ( k , n - 1 ) \cdot {y}_{t c , 1} ( k , n ) ,$$

and VAD(k,n) is the output of the voice activity detector. For n=1, the primary noise cancelling scalar β(k,1) may be defined to be 0, for every k∈[K].

In the embodiment of FIG. 4B, the estimation methods in the noise canceller unit NC comprise a LMMSEE method. In the embodiment of FIG. 4B, the secondary estimated noise signal vₑ(k,n) may be computed for every natural n and every k∈[K] according to

$${v}_{e} ( k , n ) := β ( k , n ) \cdot {y}_{t c , 1} ( k , n ) ,$$

where the primary noise cancelling scalar β(k,n) is defined, for every natural n and every k∈[K], by

$$β ( k , n ) := arg {min}_{h ∈ ℂ} 𝔼 [ {\vert {x}_{1} ( k , n ) - {h}^{*} \cdot {x}_{1} ( k , n ) \vert}^{2} ] ,$$

where [symbol] [⋅] is the expectation operator.

The hearing aid HA1 may be of a particular style (sometimes termed receiver-in-the ear, or Receiver-in-the-Ear (RITE), style) comprising a BTE-part (BTE) adapted for being located at or behind an ear of a user, and an ITE-part (ITE) adapted for being located in or at an ear canal of the user's ear and comprising a receiver (loudspeaker). The BTE-part and the ITE-part are connected (e.g. electrically connected) by a connecting element and internal wiring in the ITE- and BTE-parts (cf. e.g. wiring Wx in the BTE-part). The connecting element may alternatively be fully or partially constituted by a wireless link between the BTE- and ITE-parts (or by an acoustic tube, if the loudspeaker is located in the BTE-part). The hearing aid HA1 may be a BTE, and ITE, an I-the-Canal (ITC) and Completely-in-the-Canal (CIC), a Receiver-in-Canal (RIC), a RITE, an Open Fit, or any combination thereof.

FIG. 5 shows a schematic block diagram description of an embodiment of a binaural hearing device comprising a first hearing aid HA1 and a second hearing aid HA2. In the embodiment depicted in FIG. 5, each of the hearing aids HA1, HA2 comprise all the elements and features of the embodiment represented in FIG. 1. In the embodiment depicted in FIG. 5, each of the hearing aids HA1, HA2 comprise a wireless transceiver WT allowing to establish a wireless link between the hearing aids HA1, HA2 such that the first hearing aid HA1 receives an electric signal \tilde{x}₂(\tilde{k},n) from the second hearing aid HA2, and such that the second hearing aid HA2 receives an electric signal \tilde{x}₁(\tilde{k},n) from the first hearing aid HA1. In the embodiment depicted in FIG. 5, the workings of the second hearing aid HA2 may be understood as being the same as the workings of the embodiment described in FIG. 2 changing the subindexes “₁” for “₂” and changing the subindexes “₂” for “₁”. Note that the embodiment depicted in FIG. 5 comprises a wireless transceiver WT given that a wireless receiver WR as the one comprised in the embodiment depicted in FIG. 1 would not be enough to allow for the wireless link WL between the hearing aids HA1, HA2. Note that embodiments analogous to the one depicted in FIG. 5 in which, instead of wirelessly linking two hearing aids HA1, HA2 according to the embodiment depicted in FIG. 2, two hearing aids, each of them according to any one of embodiments depicted in FIGS. 2-4B, are wirelessly linked to each other are also disclosed.

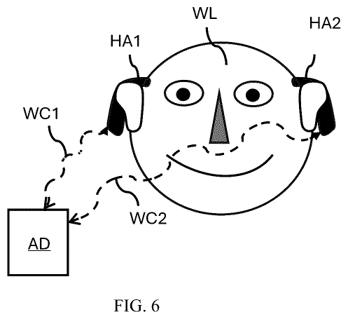

FIG. 6 shows a schematic description of an embodiment of a binaural hearing device comprising a first hearing aid HA1 and a second hearing aid HA2 where the wireless transceiver allows to create a wireless link WL between the first and second hearing aid HA1, HA2, a first wireless connection WC1 between the first hearing aid HA1 and an auxiliary device AD, and a second wireless connection WC2 between the second hearing aid HA2 and the auxiliary device AD. The auxiliary device AD may be any device, e.g. a smartphone, a smartwatch, a tablet, a computer, a smart TV, or any combination thereof.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. more, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. more, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, where reference to an element in the singular is not intended to mean “one and only one” unless specifically so stated, but rather “one or more.” The term “some” refers to one or more.

1. A hearing aid (HA1) comprising:
an input unit (IU) configured to provide a primary electric signal (x₁(k,n)) in the frequency domain comprising a number K frequency bands, wherein the primary electric signal (x₁(k,n)) represents sound in the environment of the hearing aid;
a frequency band to channel unit (FB2C) configured to provide a first secondary electric signal, wherein the frequency band to channel unit (FB2C) comprises a number of band combination units, each configured to provide a combination of the contents of two or more of K frequency bands of said primary electric signal (x₁(k,n)) to provide the first secondary electric signal with a number \tilde{K} frequency channels, wherein \tilde{K} is less than K;
a wireless receiver (WR) configured to establish a wireless link and to receive a second secondary electric signal (\tilde{x}₂(\tilde{k},n)) from another device, wherein the second secondary electric signal (\tilde{x}₂(\tilde{k},n)) comprises frequency channels corresponding to that of the first secondary electric signal x₁(k,n)) and represents sound in the environment of the hearing aid;
a first beamformer configured to determine a first beamformed signal (\tilde{y}₁(\tilde{k},n)) based on the first secondary electric signal (\tilde{x}₁(\tilde{k},n)) and the second secondary electric signal \tilde{x}₂(\tilde{k},n);
a gain unit (GU) configured to determine a first complex gain \tilde{g}₁(\tilde{k},n) for each of \tilde{K} frequency channels based on the first beamformed signal (\tilde{y}₁(\tilde{k},n)) and the first secondary electric signal (\tilde{x}₁(\tilde{k},n));
a distribution unit (DIS) configured to determine a second complex gain (g₁(k,n)) for each of K frequency channel based on the first complex gain \tilde{g}₁(\tilde{k},n); and
a processor (PRO) configured to determine a frequency domain noise reduced electric signal (y₁(k,n)) based on the second complex gains and the first primary electric signal (x₁(k,n)).

2. A hearing aid (HA1) according to claim 1, wherein the gain unit (GU) is configured to determine the first complex gain \tilde{g}₁(k,n) for each of \tilde{K} frequency channels by reducing the mean square error between the beamformed electric signal \tilde{y}₁(k,n) in said number \tilde{K} of frequency channels and the result of multiplying the first complex gains with the first secondary electric signal \tilde{x}₁(k,n) in said number \tilde{K} of frequency channels.

3. A binaural hearing system (HA1, HA2) comprising a first hearing aid (HA1) and a second hearing aid (HA2), wherein the first hearing aid (HA1) comprises:
an input unit (IU) configured to provide a primary electric signal (x₁(k,n)) in the frequency domain comprising a number K frequency bands, wherein the primary electric signal (x₁(k,n)) represents sound in the environment of the hearing aid;
a frequency band to channel unit (FB2C) configured to provide a first secondary electric signal, wherein the frequency band to channel unit (FB2C) comprises a number of band combination units, each configured to provide a combination of the contents of two or more of K frequency bands of said primary electric signal (x₁(k,n)) to provide the first secondary electric signal with a number \tilde{K} frequency channels, wherein \tilde{K} is less than K;
a wireless receiver (WR) configured to establish a wireless link and to receive a second secondary electric signal (\tilde{x}₂(\tilde{k},n)) from the second hearing aid (HA2), wherein the second secondary electric signal (\tilde{x}₂(\tilde{k},n)) comprises frequency channels corresponding to that of the first secondary electric signal x₁(k,n)) and represents sound in the environment of the hearing aid;
a first beamformer configured to determine a first beamformed signal (\tilde{y}₁(\tilde{k},n)) based on the first secondary electric signal (\tilde{x}₁(\tilde{k},n)) and the second secondary electric signal \tilde{x}₂(\tilde{k},n)
a gain unit (GU) configured to determine a first complex gain \tilde{g}₁(\tilde{k},n) for each of \tilde{K} frequency channels based on the first beamformed signal (\tilde{y}₁(\tilde{k},n)) and the first secondary electric signal (\tilde{x}₁(\tilde{k},n)),
a distribution unit (DIS) configured to determine a second complex gain (g₁(k,n)) for each of K frequency channel; and
a processor (PRO) configured to determine a frequency domain noise reduced electric signal (y₁(k,n)) based on the second complex gains.
